(19) United States
(12) Patent Application Publication
(10) Pub. No.: US 2019/0297213 A1
(43) Pub. Date: Sep. 26, 2019

(54) INFORMATION PROCESSING APPARATUS, INFORMATION PROCESSING METHOD, AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Fumitake YAMANISHI, Kanagawa (JP)

(73) Assignee: FUJI XEROX CO., LTD., Tokyo (JP)

(21) Appl. No.: 16/351,428

(22) Filed: Mar. 12, 2019

(30) Foreign Application Priority Data
Mar. 22, 2018 (JP) 2018-053858

(51) Int. Cl. H04N 1/00

(52) U.S. Cl. CPC H04N 1/00856; H04N 1/00408

(57) ABSTRACT

An information processing apparatus includes a processing section that processes content according to a variably set security state; a first acquisition section that acquires first security information indicative of a security level of the content to be processed by the processing section; a second acquisition section that acquires second security information indicative of a security state of the processing section; and a countermeasure control section that executes dynamic selection from plural predetermined countermeasures which include at least execution of a processing using the acquired first security information and second security information, and executes countermeasure control on the content.

### CROSS-REFERENCE TO RELATED APPLICATIONS

This application is based on and claims priority under 35 USC 119 from Japanese Patent Application No. 2018-053858 filed Mar. 22, 2018.

### BACKGROUND

### (i) Technical Field

The present invention relates to an information processing apparatus, an information processing method, and a non-transitory computer readable medium storing an information processing program.

### (ii) Related Art

In the related art, an information processing apparatus, which is capable of forming an image by executing a job relevant to processing of content, is known. For example, various technologies are proposed to automatically transmit image information, which is read by a scanner, toward an external apparatus.

JP4247138B discloses an apparatus which extracts a character string by executing an Optical Character Recognition (OCR) process with respect to read and input manuscript data, and which generates transmission information of an electronic mail using the character string. In addition, JP4247138B discloses provision of a security function to an image forming apparatus in order to protect data from being illegally manipulated.

### SUMMARY

However, JP4247138B does not disclose a detailed countermeasure method according to a security level of content. For example, in a case where a security state of content processing means is fixedly set, there is a possibility that it is not possible to respectively execute proper works for various pieces of content.

Aspects of non-limiting embodiments of the present disclosure relate to an information processing apparatus, an information processing method, and a non-transitory computer readable medium storing an information processing program, which execute a more appropriate countermeasure according to a security level of content, compared to a case of fixedly working the security state which is set to the content processing means.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processing section that processes content according to a variably set security state; a first acquisition section that acquires first security information indicative of a security level of the content to be processed by the processing section; a second acquisition section that acquires second security information indicative of a security state of the processing section; and a countermeasure control section that executes dynamic selection from a plurality of predetermined countermeasures which include at least execution of a processing using the acquired first security information and second security information, and executes countermeasure control on the content.

### BRIEF DESCRIPTION OF THE DRAWINGS

Exemplary embodiment(s) of the present invention will be described in detail based on the following figures, wherein:

FIG. 1 is a diagram illustrating a whole configuration of an information processing system according to a first exemplary embodiment;

FIG. 2 is a first sequence diagram illustrating an operation of a control unit of FIG. 1;

FIG. 3 is a second sequence diagram illustrating an operation of the control unit of FIG. 1;

FIG. 4 is a functional block diagram illustrating security components illustrated in FIGS. 2 and 3;

FIG. 5A is a graph schematically illustrating a result of setting of a security state according to a comparison example, and FIG. 5B is a graph schematically illustrating a result of setting of a security state according to an example;

FIG. 6 is a flowchart relevant to countermeasure control executed by the security components of FIG. 4;

FIG. 7 is a diagram illustrating an example of a data structure included in a guideline file of FIG. 4;

FIG. 8 is a diagram illustrating a whole configuration of an information processing system according to a second exemplary embodiment;

FIG. 9 is a first sequence diagram illustrating operations of a control unit and a mobile terminal of FIG. 8;

FIG. 10 is a second sequence diagram illustrating operations of the control unit and the mobile terminal of FIG. 8;

FIG. 11 is a functional block diagram illustrating security components illustrated in FIGS. 9 and 10; and

FIG. 12 is a configuration diagram illustrating an information processing apparatus according to a modification example of the first and second exemplary embodiments.

### DETAILED DESCRIPTION

### First Exemplary Embodiment

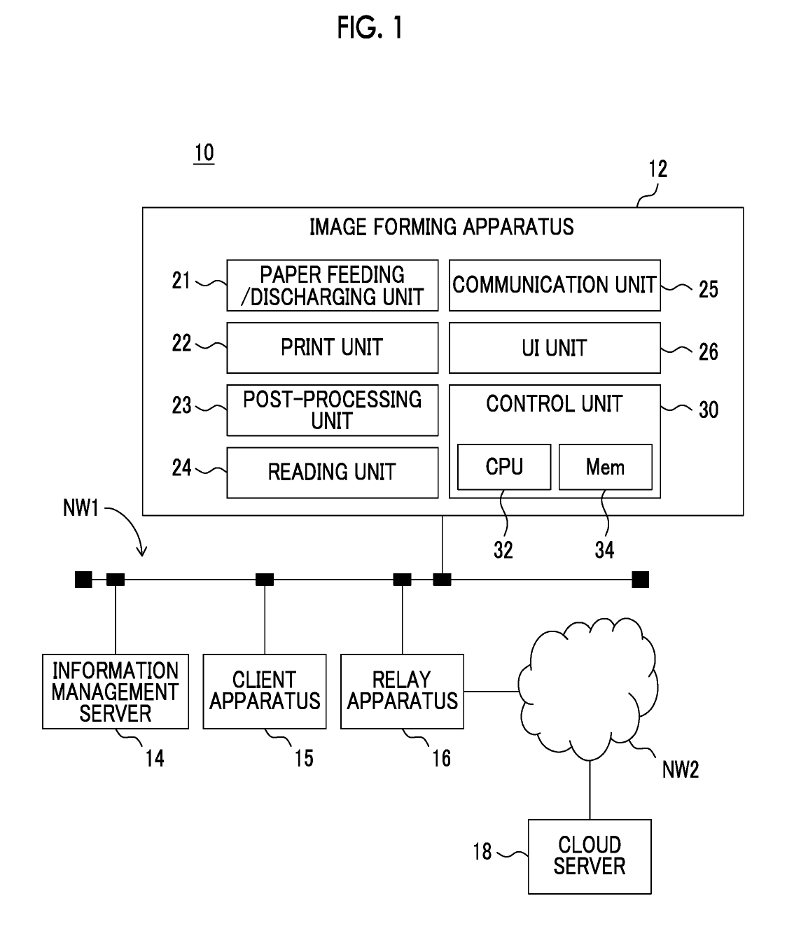

An information processing system according to a first exemplary embodiment of the present invention will be described with reference to FIGS. 1 to 7. Meanwhile, the information processing system is not limited to an apparatus configuration or a network configuration illustrated in the drawings.

Configuration of Information Processing System 10 FIG. 1 is a diagram illustrating a whole configuration of an information processing system 10 according to the first exemplary embodiment. The information processing system 10 is a system which supports an office task by executing a desired information processing using an image forming apparatus 12 which will be described later. Specifically, the information processing system 10 is configured to include the image forming apparatus 12 (information processing apparatus), an information management server 14, one or more client apparatuses 15, a relay apparatus 16 which functions as a gateway, and a cloud server 18.

The image forming apparatus 12, the information management server 14, each of the client apparatuses 15, and the relay apparatus 16 are connected to each other via a network NW1 (so-called an intranet) which is constructed in an office. Therefore, the respective apparatuses, which are connected to the network NW1, are communicably connected to the cloud server 18 in bi-direction through the relay apparatus 16 and the network NW2 (so-called the Internet).

The image forming apparatus 12 is configured to include a paper feeding/discharging unit 21, a print unit 22, a post-processing unit 23, a reading unit 24, a communication unit 25, a UI unit 26 (user interface section), and a control unit 30.

The paper feeding/discharging unit 21 is a unit that supplies a recording medium, on which an image is to be formed, and that discharges the recording medium on which the image is formed. The print unit 22 is, for example, a unit that executes a printing process on the recording medium using an electronic picture method or an ink jet method. The post-processing unit 23 is, for example, a unit that executes a post processing which includes a paper folding process, a binding process, and a punching process.

The reading unit 24 is a unit that reads the image which is formed on the recording medium. The communication unit 25 is a unit that executes a communication process with an external apparatus (for example, the information management server 14). The UI unit 26 is a unit that is configured to be able to receive an input manipulation (including a manipulation of setting a security state) executed by a user through a hardware button or a touch panel.

The control unit 30 is a unit that is configured to include a processor 32 and a memory 34, and that generally controls respective units which configure the image forming apparatus 12. Under the control of the control unit 30, the image forming apparatus 12 realizes at least one function of a printer function, a copy function, a scan function, a facsimile function, or a data transmission function.

The processor 32 is an arithmetic processing apparatus which includes a Central Processing Unit (CPU) and a Micro-Processing Unit (MPU). The memory 34 is non-transient and is a computer-readable storage medium. Here, the computer-readable storage medium includes a portable medium, such as a magneto-optical disk, a ROM, a CD-ROM, or a flash memory, and a storage device such as a hard disk which is built in a computer system.

The information management server 14 is a computer that is configured to be able to execute various processes related to information processing of the image forming apparatus 12. In addition, the information management server 14 may store information (for example, user information, security information, or data management information) which is necessary to work the image forming apparatus 12, or may timely provide the information at request of the image forming apparatus 12.

Operation of Information Processing System 10

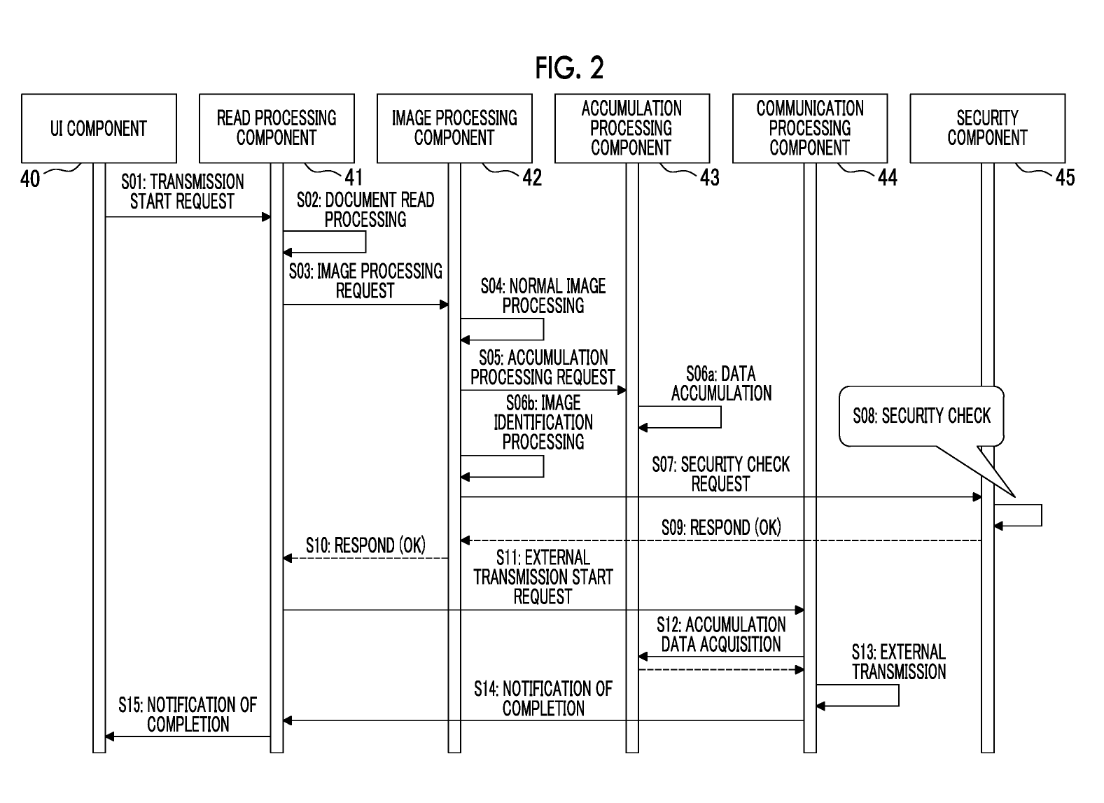

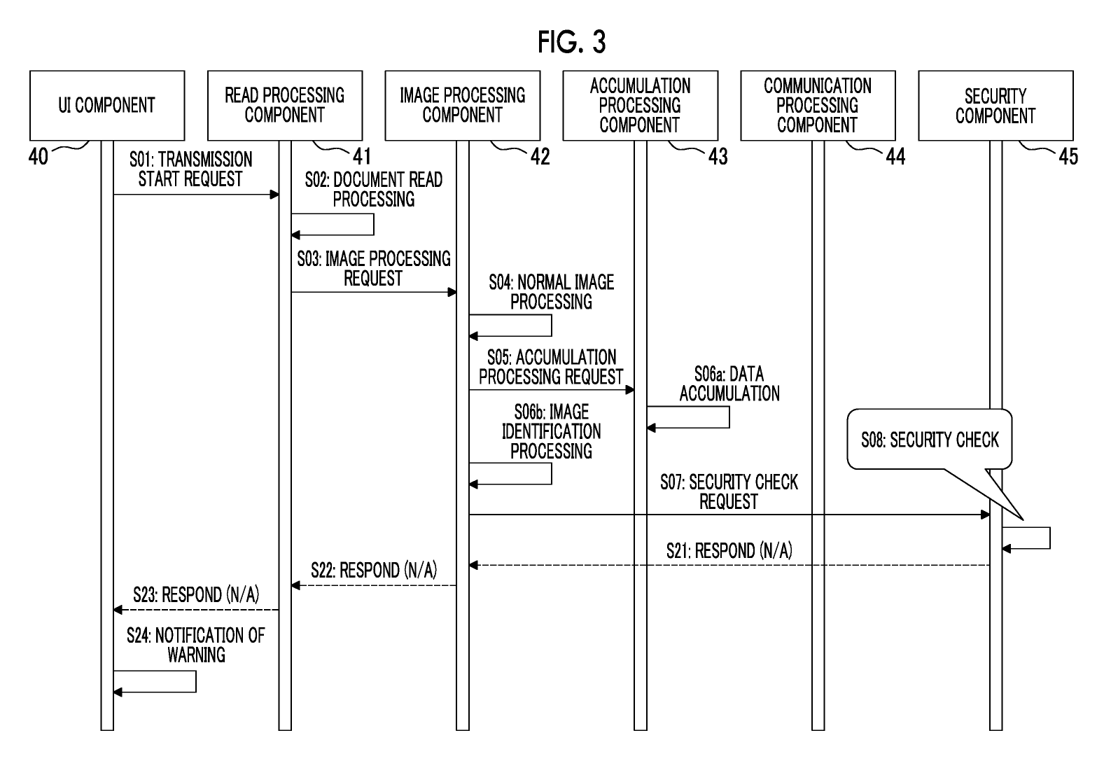

Subsequently, an operation of the information processing system 10 illustrated in FIG. 1, more specifically, a scan transmission operation of the image forming apparatus 12 will be described using sequence diagrams of FIGS. 2 and 3. The “scan transmission” means an operation of reading and digitizing a document of paper (paper document) and transmitting acquired document data to the outside. Meanwhile, in the first exemplary embodiment, a fact should be remarked that not only the document of paper (analog content) but also the document data (digital content) are included in “content”.

FIG. 2 is a first sequence diagram illustrating an operation of the control unit 30 of FIG. 1. In an example of FIG. 2, middleware, which is capable of executing six components, is installed in the control unit 30. The six components include a UI component 40, a read processing component 41, an image processing component 42, an accumulation processing component 43, a communication processing component 44, and a security component 45.

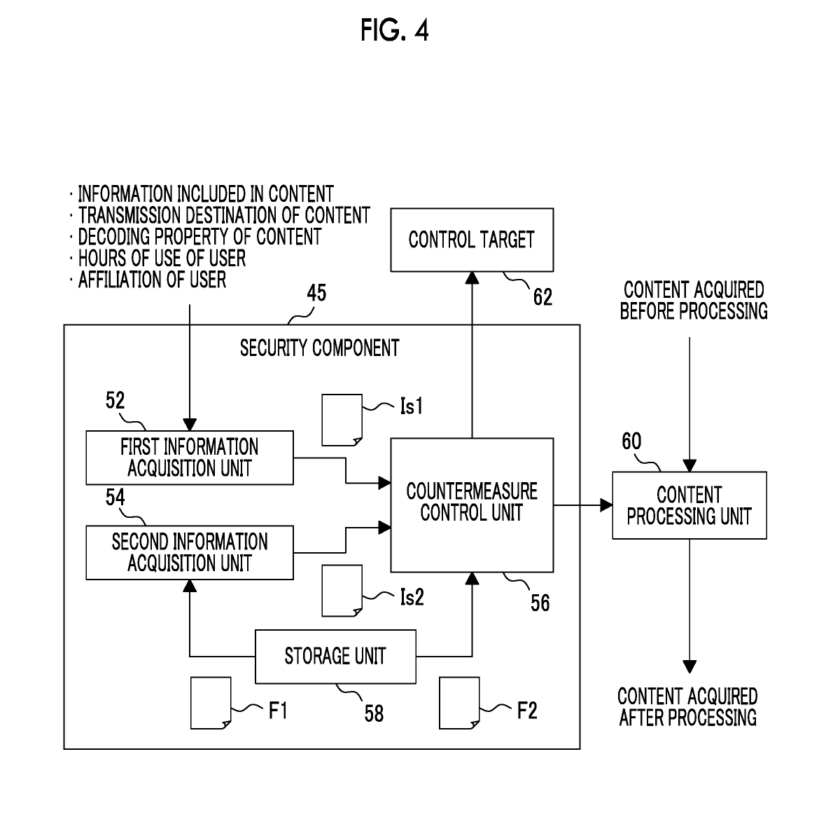

Prior to the scan transmission operation, the user who corresponds to a content provision source (hereinafter, also referred to as a provision source user) executes a login manipulation with respect to the image forming apparatus 12, and inputs identification information, which includes a user ID and a password, from the UI unit 26. In addition, the provision source user sets the document of paper (so-called a manuscript) to a predetermined location of the reading unit 24.

[S01] The UI component 40 receives an input manipulation (for example, touch manipulation) which is predetermined by the provision source user, and outputs a signal, which indicates a request for preparation and transmission of the document data, toward the read processing component 41.

[S02] The read processing component 41 receives the signal from the UI component 40, and executes a read processing with respect to the document of paper which is set by the reading unit 24.

[S03] The read processing component 41 outputs a signal, which indicates a request for an image processing of scan data in a raster format acquired through the read processing, toward the image processing component 42.

[S04] The image processing component 42 receives the signal from the read processing component 41, and executes a desired image processing with respect to the scan data.

[S05] The image processing component 42 outputs a signal, which indicates a request for an accumulation processing of the document data (in the raster format or a vector format) acquired through the image processing, toward the accumulation processing component 43.

[S06a] The accumulation processing component 43 receives the signal from the image processing component 42, and executes the accumulation processing of the document data. [S06b] In contrast, the image processing component 42 extracts first security information Is1 (FIG. 4), which will be described later, by executing a text identification processing using an OCR function with respect to the document data.

[S07] The image processing component 42 outputs a signal, which indicates a request for check of the content relevant to information security (hereinafter, referred to as security check), toward the security component 45.

[S08] The security component 45 executes the security check using various pieces of information relevant to the content. Here, it is assumed that the security component 45 acquires a result of determination of approving content transmission (OK).

[S09] The security component 45 responds to the request (S07) from the image processing component 42 by outputting a signal, which indicates “OK”, toward the image processing component 42.

[S10] The image processing component 42 responds to the request (S03) from the read processing component 41 by outputting the signal, which indicates “OK”, toward the read processing component 41.

[S11] The read processing component 41 outputs a signal, which indicates a request for a process transmitting of accumulated document data, toward the communication processing component 44.

[S12] The communication processing component 44 receives a signal from the read processing component 41, and acquires transmission target document data from the accumulation processing component 43.

[S13] The communication processing component 44 executes the transmission process with respect to the acquired document data.

[S14] The communication processing component 44 responds to the request (S11) from the read processing component 41 by outputting a signal, which indicates completion of the transmission process, toward the read processing component 41.

[S15] The read processing component 41 responds to the request (S01) from the UI component 40 by outputting a signal, which indicates completion of the preparation and the transmission of the document data, toward the UI component 40.

For example, in a case where a specific client apparatus 15 is set to a transmission destination, the image forming apparatus 12 generates an electronic mail, which includes document data prepared by the image forming apparatus 12, and transmits the digitized mail toward the client apparatus 15. Therefore, a user who corresponds to a content provision destination (hereinafter, referred to as a provision destination user) is capable of acquiring and using content, provided from the provision source user, in a format of the document data through the client apparatus 15.

For example, in a case where the cloud server 18 is set to the transmission destination, the image forming apparatus 12 transmits the document data, which is prepared by the image forming apparatus 12, toward the cloud server 18 in a state in which security is secured using cipher communication. Therefore, a user who has an access right to the cloud server (that is, the provision destination user) is capable of acquiring and using the content, provided from the provision source user, in the format of the document data from the cloud server 18.

FIG. 3 is a second sequence diagram illustrating the operation of the control unit 30 of FIG. 1.

Since sequences in [S01] to [S07] are the same as in the operation described with reference to FIG. 2, the description thereof will not be repeated.

[S08] The security component 45 executes the security check using the various pieces of information relevant to the content. Here, it is assumed that the security component 45 acquires a result of determination of disapproving transmission of the content (N/A).

[S21] The security component 45 responds to the request (S07) from the image processing component 42 by outputting a signal, which indicates “N/A”, toward the image processing component 42.

[S22] The image processing component 42 responds to the request (S03) from the read processing component 41 by outputting the signal, which indicates “N/A”, toward the read processing component 41.

[S23] The read processing component 41 responds to the request (S01) from the UI component 40 by outputting the signal, which indicates “N/A”, toward the UI component 40.

[S24] The UI component 40 executes a notification process of providing a notification that the transmission of the document data is not approved to the outside. Therefore, warning is executed with respect to the provision destination user who is near to the image forming apparatus 12.

Details of Countermeasure Control

FIG. 4 is a functional block diagram illustrating the security component 45 illustrated in FIGS. 2 and 3. The security component 45 is configured to include a first information acquisition unit 52 (first acquisition section), a second information acquisition unit 54 (second acquisition section), a countermeasure control unit 56 (countermeasure control section), and a storage unit 58 (storage section). Meanwhile, in the storage unit 58, a plurality of types of data (for example, a setting file F1 and a guideline file F2) are stored.

The countermeasure control unit 56 controls at least one of a content processing unit 60 or a control target 62. Here, the content processing unit 60 (processing section) is a unit that processes the content according to a variably set security state, and may be, for example, the print unit 22 or the communication unit 25. In addition, the control target 62 is a unit that executes a countermeasure relevant to a processing of the content, and may be, for example, the communication unit 25, the UI unit 26, or the control unit 30.

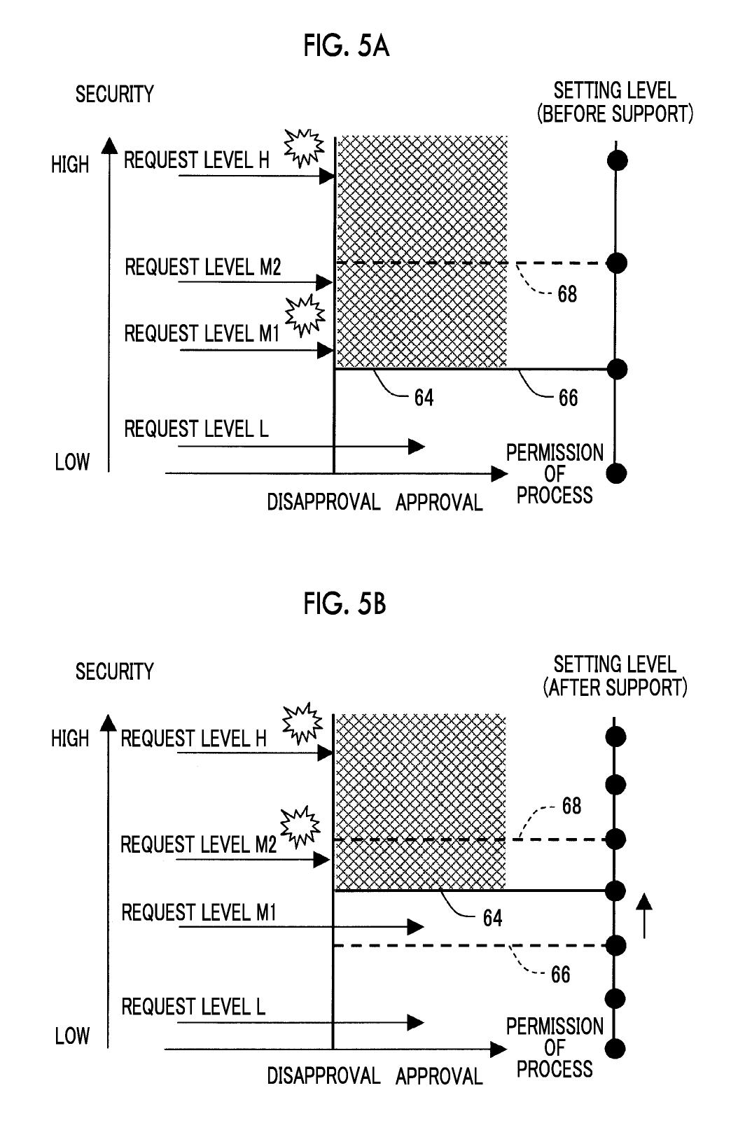

Hereinafter, the countermeasure control which is executed by the security component 45 will be conceptually described with reference to FIGS. 5A and 5B. FIG. 5A is a graph schematically illustrating a result of setting of a security state according to a comparison example. FIG. 5B is a graph schematically illustrating a result of setting of a security state according to an example.

In FIGS. 5A and 5B, a vertical axis of each graph indicates height (high and low) of security and a horizontal axis of the graph indicates permission (approval or disapproval) of the process, respectively. Arrows which extend along the horizontal axis respectively indicate security levels (hereinafter, request levels) which are requested for the processing of the content. A threshold 64 corresponds to an upper limit value of the request level in which the processing of the content is approved. That is, an area of double hatching corresponds to a “security wall” in which a process at the request level that is higher than the threshold 64 is not approved.

As illustrated in FIG. 5A, it is assumed that the permission of a process for four-stage request levels, that is, L, M1, M2, and H is determined. In a security state, in which the threshold 64 corresponding to a current setting level 66 is set between the request levels L and M1, one request level L is approved. In contrast, the remaining three request levels M1, M2, and H are not approved. Here, a worker (for example, a machine manager) who has a security setting right changes a setting of the security state through the UI unit 26 (FIG. 1) and attempts to additionally approve only one request level M2.

However, with regard to this type of setting manipulation, the number of types and options of setting items is large and expert knowledge relevant to a network technology is necessary. Since the worker executes complex and elaborate setting works, there is a case where it is not possible to execute adjustment at a detailed setting level. For example, it is assumed that setting of lifting to the setting level 68 on one ranking is executed. As a result, the request level M1 is approved as planned, and, in contrast, the request level M2 is also approved unexpectedly.

Here, in the exemplary embodiment, as illustrated in FIG. 5B, under the countermeasure control of the countermeasure control unit 56, adjustment at the detailed setting level is supported. For example, it is assumed that setting of lifting the threshold 64 to an intermediate location of the two setting levels 66 and 68 is executed through an appropriate countermeasure. As a result, a desired security state in which the request level M1 is approved, and, in contrast, the request level M2 is not approved may be realized.

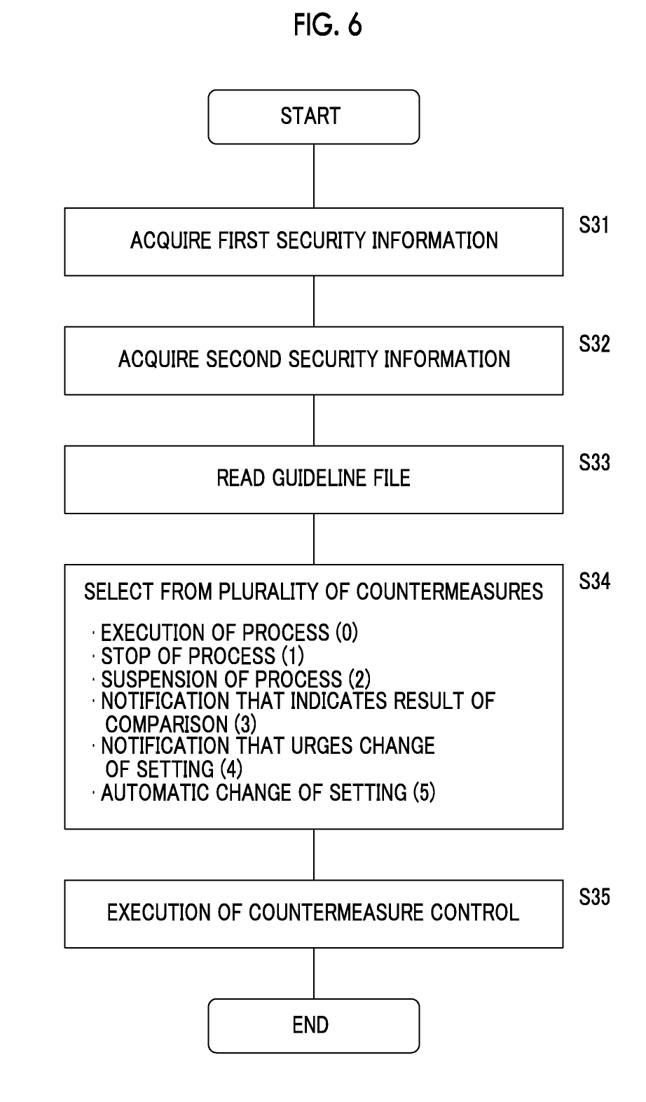

Subsequently, the countermeasure control, which is executed by the security component 45 of FIG. 4, will be described in detail with reference to a flowchart of FIG. 6.

In step S31 of FIG. 6, the first information acquisition unit 52 acquires information (hereinafter, referred to as first security information Is1) indicative of the security level of the content. Here, the first security information Is1 may include at least one piece of [1] information included in the content, [2] information indicative of a transmission destination of the content, [3] information indicative of a decoding degree of the content, [4] information indicative of hours of use of the user, or [5] information indicative of an affiliation of the user. In a case of using various pieces of information in which there is a high possibility of being acquired in a process of treating the content, it is possible to specify the security level of the content at a high accuracy.

The “information included in the content” means partial information (a text, a figure, a symbol, or a combination thereof) in which it is possible to specify confidentiality or an informational value of the content. A keyword, which indicates height of the confidentiality, includes, for example, a contract, a settlement, a consultation, an estimate, an orderer, an attention book, top secret, or a company secret. Evaluation may be acquired such that the confidentiality is relatively high (a security request level is high) in a case where the transmission target document data includes the keyword, and the confidentiality is relatively low (request level is low) in a case where the transmission target document data does not include the keyword. Meanwhile, a keyword, which indicates height of the informational value, includes various keywords (specifically, identification information indicative of information sending source which has a sending force or a keyword which has high importance or popularity relevant to a company business) which are previously set by the user.

Information which is capable of specifying the “transmission destination of the content” includes a user name, an account name, a domain name, a mail address, and an IP address. For example, a warning degree with respect to information leakage may be evaluated according to whether the transmission destination, which is designated by the provision source user, is already known or is not known yet. The evaluation may be executed such that a warning degree is relatively low (the security request level is low) in a case where the transmission destination is registered in an address book, and the warning degree is relatively high (the request level is high) in a case where the transmission destination is not registered in the address book.

The “decoding degree of the content” includes not only a decoding degree of the document data itself but also a decoding degree of the content itself of the document (a type of language or a quantity of technical terms). For example, the evaluation may be executed such that the decoding degree is relatively low (the security request level is low) in a case where a cipher process is executed on the transmission target document data, and the decoding degree is relatively high (the request level is high) in a case where the cipher process is not executed.

The “hours of use of the user” may be set for each user or for each group, for example, in units of time unit such as “time zones of one day” (from 9 am to 17 pm) or “days of one week” (weekday/holiday). Specifically, the warning degree with respect to the information leakage may be evaluated according to whether or not the provision source user executes a manipulation within normal task time. The evaluation may be executed such that the warning degree is relatively low (the security request level is low) in a case where the provision destination user executes login within the normal task time, and the warning degree is relatively high (the request level is high) in a case where the user performs login out of the normal task time.

The “affiliation of the user” may be set for each user, for example, in units of configuration such as a company, an office, a department, a team, a group, and a project. Specifically, the warning degree with respect to the information leakage may be evaluated according to a degree of relation of a task between the provision source user and the provision destination user. The evaluation may be executed, by taking a combination of affiliations into consideration, such that the warning degree is relatively low (the security request level is low) in a case where the degree of relation on the task is high, and the warning degree is relatively high (the request level is high) in a case where a degree of intimateness on the task is low.

In step S32, the second information acquisition unit 54 acquires information (hereinafter, second security information Is2) indicative of a security state of the content processing unit 60. Specifically, the second information acquisition unit 54 acquires setting information (for example, a communication protocol, a cipher suite, a block cipher mode, or a key exchange method), which is input through the UI unit 26, as the second security information Is2 by reading the setting file F1 which is stored in the storage unit 58. In a case of using various pieces of information in which there is a high possibility of being acquired in a process of treating the content, it is possible to specify the security state of the content processing unit 60 with high accuracy.

The “communication protocol” includes communication protocols (for example, TLSv1.0/TLSv1.1/TLSv1.2/SSLv3), which correspond to the same type but have different versions, in addition to HTTP, HTTPS, TLS, and SSL. Evaluation may be executed such that the security level is relatively low in a case of the “HTTP” in which the cipher communication is not used, and the security level is relatively high in a case of the “HTTPS” in which the cipher communication is used. In addition, evaluation may be executed such that the security level is relatively low in a case of the “TLSv1.0” in which vulnerability is high, and the security level is relatively high in a case of the “TLSv1.2” in which the vulnerability is low.

For example, the cipher suite includes a stream cipher RC4 and a block cipher 3DES, AES, or RSA. A mode of the block cipher includes, for example, ECB, CBC, CFB, OFB, or CTR. A key exchange method includes, for example, the RSA and DH.

In step S33, the countermeasure control unit 56 reads the guideline file F2 which is stored in the storage unit 58. The guideline file F2 is a data file in which the guideline (hereinafter, referred to as a selection guideline) used to select the countermeasure is described. The guideline file F2 is timely downloaded from an external apparatus (for example, the information management server 14) through the communication unit 25, and is updated to a newest version.

In step S34, the countermeasure control unit 56 selects one or more countermeasures from a plurality of predetermined countermeasures using the first security information Is1 acquired in step S31 and the second security information Is2 acquired in step S32. Specifically, the countermeasure control unit 56 reads the guideline file F2 which is stored in the storage unit 58, and executes the countermeasure control according to the acquired selection guideline.

The “countermeasure” means a countermeasure relevant to the processing of the content. A detailed example of the countermeasure includes [0] execution of a process (countermeasure 0), [1] stop of the process (countermeasure 1), [2] suspension of the process (countermeasure 2), [3] notification that indicates a result of comparison of information (countermeasure 3), [4] notification that urges manual change of the security state (countermeasure 4), and [5] automatic change of the security state (countermeasure 5).

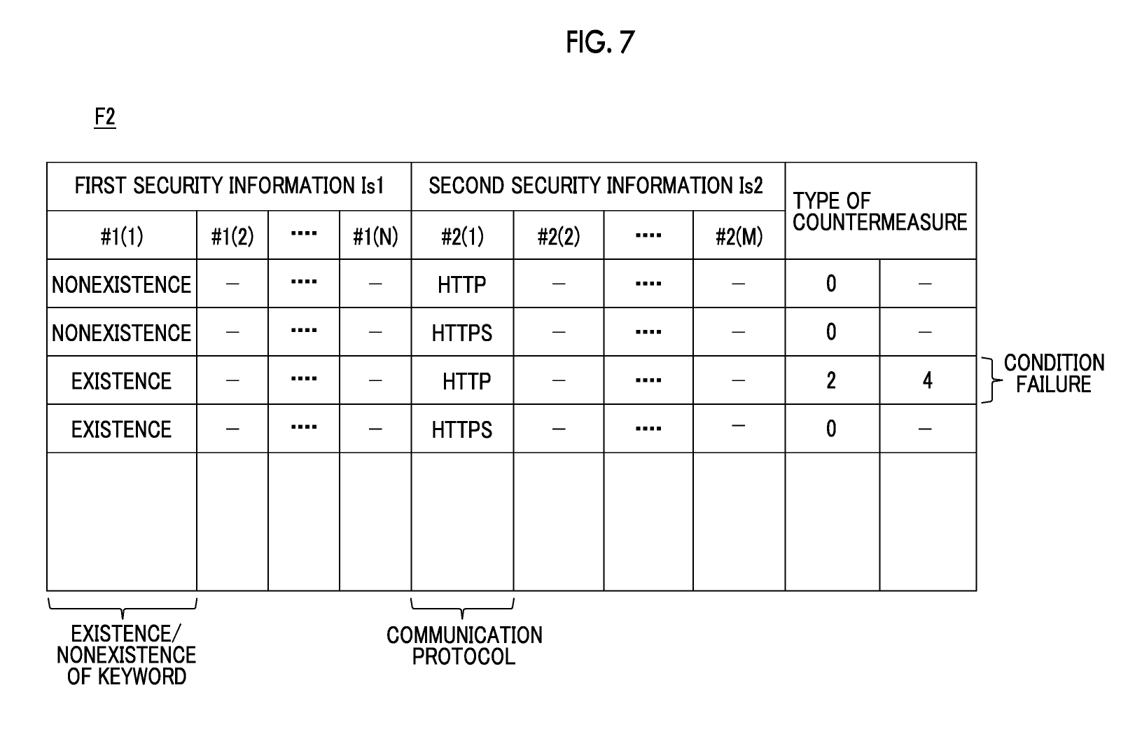

FIG. 7 is a diagram illustrating an example of a data structure included in the guideline file F2 of FIG. 4. As being understood from FIG. 7, the guideline file F2 indicates a corresponding relationship between a combination of the first security information Is1 (maximally N number of information sets) and the second security information Is2 (maximally M number of information sets) and the type of the countermeasure (identification number: 0 to 5).

For example, it is assumed that a classification #1(1) is “existence/non-existence of a keyword” and a classification #2 (1) is a “communication protocol type”. As being understood from FIG. 7, four selection rules are sequentially described from the top in the guideline file F2.
In a case where setting is executed such that a specific keyword is not included in the document data and HTTP is used, the transmission process is executed in conformity to HTTP.
In a case where setting is executed such that the specific keyword is not included in the document data and HTTPS is used, the transmission process is executed in conformity to HTTPS.
In a case where setting is executed such that the specific keyword is included in the document data and HTTP is used, the transmission process is suspended and a notification that urges a change of the setting of the security state is provided.
In a case where setting is executed such that the specific keyword is not included in the document data and HTTPS is used, the transmission process is executed in conformity to HTTPS.

Meanwhile, a countermeasure selection guideline is not limited to an example of FIG. 7, and various guidelines may be taken into consideration. For example, the combination of both the pieces of information may have many-to-one, one-to-many, and many-to-many relations in addition to a one-to-one relation. As a detailed example, addition of the “hours of use of the user” to the classification #1(2) and addition of the “cipher suite” to the classification #2(2) may be taken into consideration.

In addition, the countermeasure selection guideline is not limited to the above-described conditional branches and may be a rule based on quantification of the security level and/or the security state (refer to FIGS. 5A and 5B). For example, the countermeasure control unit 56 may select at least one countermeasure according to a magnitude relation between a first evaluation value calculated from the first security information Is1 and a second evaluation value calculated from the second security information Is2. In this case, in the guideline file F2, for example, pieces of information indicative of [1] an evaluation item, [2] a degree of contribution with respect to the evaluation value, [3] a method for calculating the evaluation value, and [4] a relation between the evaluation value and the countermeasure may be stored.

As above, the countermeasure control unit 56 may read the guideline file F2 (data in a file format) which is stored in the storage unit 58, and may execute the countermeasure control according to the acquired selection guideline. A case is assumed where necessity for a change of a security policy of the apparatus at high frequency is generated in order to correspond to a development speed of a security technology. Here, in a case where a configuration, in which the guideline file F2 that includes the selection guideline is readably stored, is used, the change in the security policy is easily reflected, compared to a case where a program itself which functions as the countermeasure control unit 56 is changed.

In addition, the countermeasure selection guideline may be sequentially updated according to a learning process. For example, the countermeasure control unit 56 may collect and learn content of a security measure executed by the worker in the past, and may select the countermeasure based on a result of the learning. The result of the learning includes, specifically, a number of times of permission until generation of the selection guideline, update of the selection guideline (change and addition of a rule), and transition of the countermeasure (for example, current countermeasure 4→countermeasure 5).

Since the countermeasure control unit 56 executes one or more countermeasures, which are selected in step S34, in step S35, a control signal is output toward the content processing unit 60 and/or the control target 62. In the countermeasures 0 to 2 (execution/stop/suspension), the content processing unit 60 is the communication unit 25. Meanwhile, the UI unit 26 may be added to the control target in order to notify the provision source user of each operation situation.

In the countermeasures 3 and 4 (notifications), the control target 62 is at least the UI unit 26. In the countermeasure 5 (automatic change), the control target 62 is at least the control unit 30. In addition, in order to provide a notification that the security state is automatically changed to a third person, the communication unit 25 or the UI unit 26 may be added to the control target 62.

An example of the countermeasure 3 includes a countermeasure to display a result of determination of whether or not the security condition is satisfied or a countermeasure to display a type or content of the setting item which does not satisfy the security condition. An example of the countermeasure 4 includes a countermeasure to display a message that urges the change of the setting or a countermeasure to display a recommendation value of setting information in which it is possible to satisfy the security condition. An example of the countermeasure 5 includes a countermeasure to temporarily or permanently update the content of the setting file F1 in order to satisfy the security condition.

However, in a case where the security state of the content processing unit 60 does not satisfy the security condition which approves the processing of the content, the countermeasure control unit 56 may execute the countermeasure control (here, the countermeasures 4 and 5) in order to change the currently set security state into a security state which satisfies the security condition, instead of selecting the countermeasures 2 and 3. A reason for this is that, in a case where the security state is changed according to the selected and executed countermeasure, the processing of the content, which is not approved, is approved. Therefore, there is an advantage in that a situation, in which the processing of the content is stagnant due to a failure of the security condition, is prevented from occurring.

For example, in a case where the security state of the content processing unit 60 is changed, the countermeasure control unit 56 may limit a lifting width of an upper limit (the threshold 64 of FIGS. 5A and 5B) of the security level in which the processing of the content is approved. A reason for this is that a limit in the security state imposed to the content processing unit 60 is prevented from being defused more than necessary. As a result, it is possible to prevent a situation, in which the vulnerability of the security is actualized later, from occurring.

A method for limiting the lifting width includes, for example, [1] a method for approving a change with respect to a part (specific type) of the plurality of setting items, [2] a method for approving a change with respect to a part (specific number) of the plurality of setting items, [3] a method for approving selection of only a part of the plurality of pieces of content which is allowed to be selected in one setting item, or [4] a combination of the above three methods.

In addition, in a case where the worker inputs the setting information indicative of the security state through user interface section which includes the UI unit 26 (FIG. 1), there is a tendency that customizing of the setting becomes easy and, in contrast, it is difficult to accurately grasp the security state which is complexly set. Here, the countermeasure control unit 56 may execute the countermeasure control such that an item or content of the setting information to be changed is output to the UI unit 26. Therefore, the user is supported who executes the change in the setting information through the user interface section, and it is possible to reduce job labors which are necessary to change the security state.

In addition, together with or separately from the output to the UI unit 26, the countermeasure control unit 56 may execute the countermeasure control, together with the notification that the security state is automatically changed or the notification that urges manual change of the security state. Therefore, a notification that it is necessary to change the security state is timely provided.

### Advantage of First Exemplary Embodiment

As described above, the image forming apparatus 12 as the information processing apparatus according to the first exemplary embodiment includes [1] the content processing unit 60 (processing section) that processes the content according to a variably set security state, [2] the first information acquisition unit 52 (first acquisition section) that acquires the first security information Is1 indicative of the security level of the content to be processed by the content processing unit 60, [3] the second information acquisition unit 54 (second acquisition section) that acquires the second security information Is2 indicative of a security state of the content processing unit 60, and [4] the countermeasure control unit (countermeasure control section) that executes dynamic selection from the plurality of predetermined countermeasures which includes at least execution of the process using the acquired first security information Is1 and second security information Is2, and executes the countermeasure control to the content.

In addition, according to the information processing method and the non-transitory computer readable medium storing an information processing program according to the first exemplary embodiment, [1] the image forming apparatus 12 (information processing apparatus), which includes the content processing unit 60 (processing section) that processes the content according to the variably set security state, executes [2] a first acquisition step (S31) of acquiring the first security information Is1 indicative of the security level of the content to be processed by the content processing unit 60, [3] a second acquisition step (S32) of acquiring the second security information Is2 indicative of the security state of the content processing unit 60, [4] a countermeasure control step (S35) of executing dynamic selection from the plurality of predetermined countermeasures, which include at least execution of the process, using the acquired first security information Is1 and second security information Is2, and executing the countermeasure control on the content.

As above, in a case where the countermeasure relevant to the processing of the content (specifically, the scan transmission) is dynamically selected and executed using the first security information Is1 and the second security information Is2, it is possible to execute a more appropriate countermeasure according to the security level of the content, compared to a case of fixedly working the security state which is set to the content processing unit 60 (specifically, the communication unit 25).

### Second Exemplary Embodiment

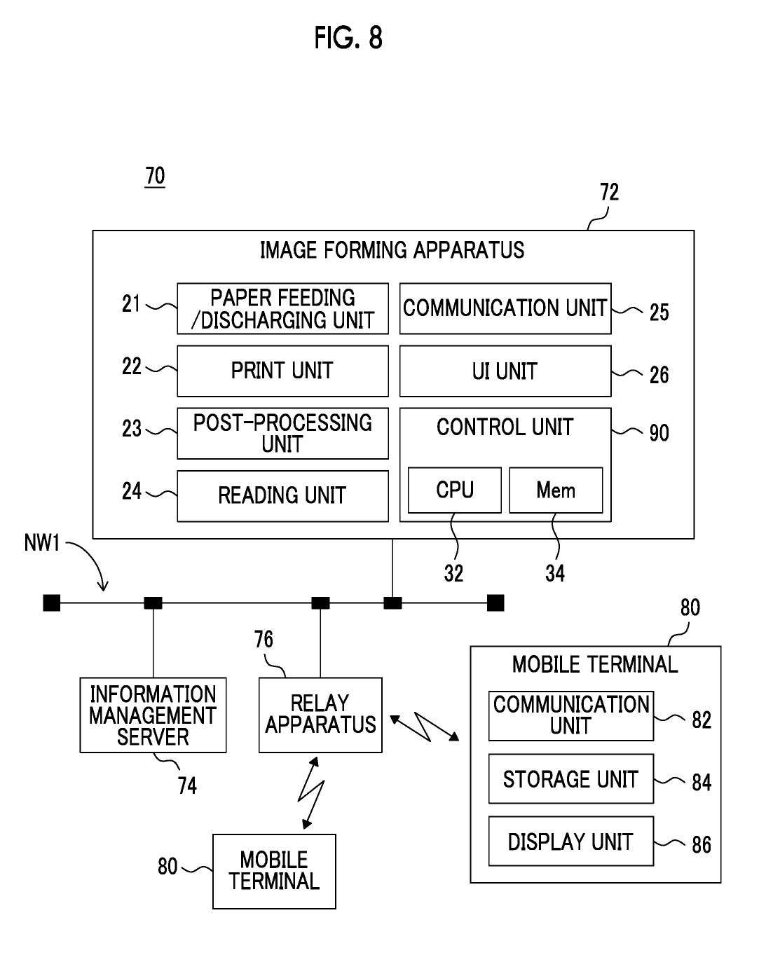

Subsequently, an information processing system 70 according to a second exemplary embodiment will be described with reference to FIGS. 8 to 11. Meanwhile, the same reference symbols are attached to identical configurations and functions as in the first exemplary embodiment, and the description thereof will not be repeated.

Configuration of Information Processing System 70

FIG. 8 is a diagram illustrating a whole configuration of the information processing system 70 according to the second exemplary embodiment. The information processing system 70 is a system which supports an office task by executing a desired information processing using an image forming apparatus 72 which will be described later. Specifically, the information processing system. 70 is configured to include an image forming apparatus 72 (information processing apparatus), an information management server 74, a relay apparatus 76 that functions as a wireless access point, and one or more mobile terminals 80.

The image forming apparatus 72, the information management server 74, and the relay apparatus 76 are connected to each other via a network NW1 (so-called an Intranet) which is constructed in an office. Therefore, the respective apparatuses, which are connected to the network NW1, are communicably connected to the respective mobile terminals 80 in bi-direction through the relay apparatus 76.

The mobile terminal 80 is a multifunction and multipurpose apparatus which is allowed to be carried and used by the user, and includes, specifically, a tablet, a smart phone, or a wearable computer. The mobile terminal 80 is configured to include a communication unit 82 used to communicate with an external apparatus, a storage unit 84 used to store document data, and a display unit 86 used to display an image or a message.

The image forming apparatus 72 is configured to include a paper feeding/discharging unit 21, a print unit 22, a post-processing unit 23, a reading unit 24, a communication unit 25, a UI unit 26, and a control unit 90 which has a function different from the first exemplary embodiment (the control unit 30 of the FIG. 1).

Operation of Information Processing System 70

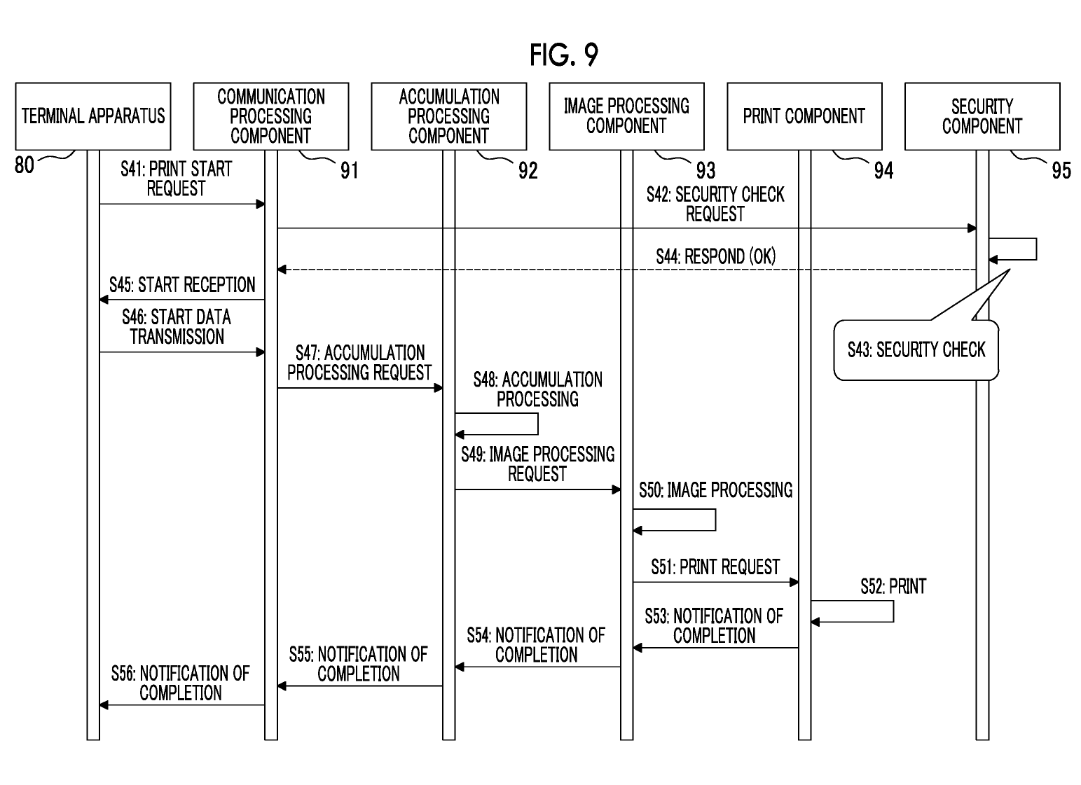

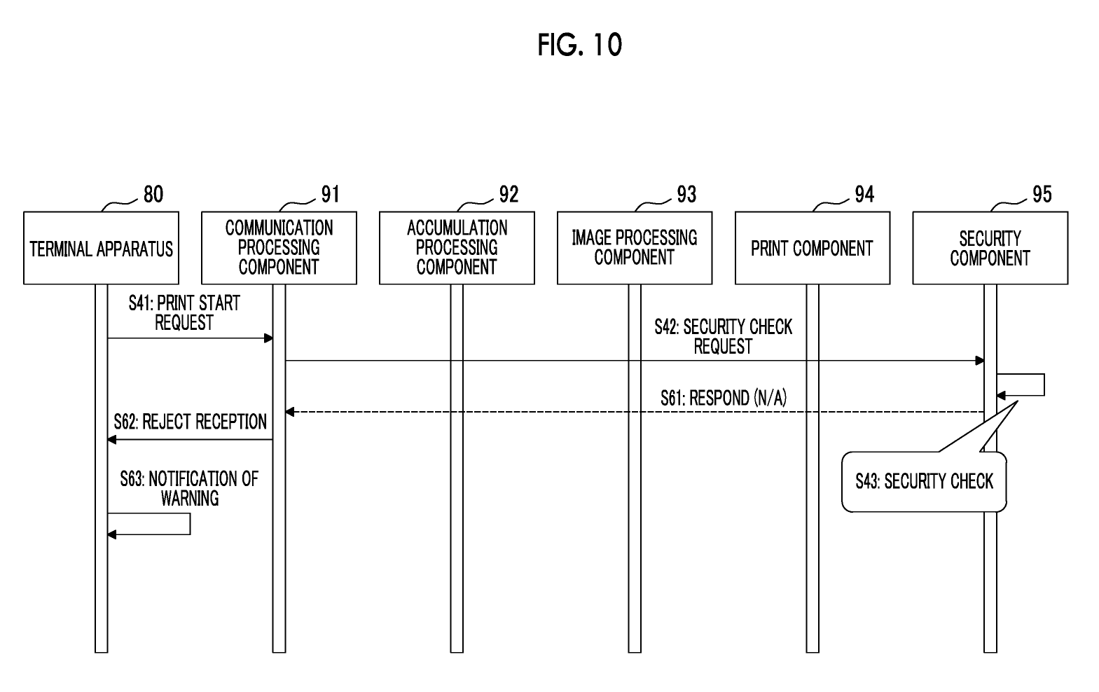

Subsequently, an operation of the information processing system 70 illustrated in FIG. 8, more specifically, a mobile print operation of the image forming apparatus 72 will be described with reference to sequence diagrams of FIGS. 9 and 10. The “mobile print” means an operation for receiving the document data from the external mobile terminal 80 and printing the document data on a recording medium. Meanwhile, in the second exemplary embodiment, the document data, which is a print target, corresponds to “content” (digital content).

FIG. 9 is a first sequence diagram illustrating operations of the control unit 90 and the mobile terminal 80 of FIG. 8. In an example of FIG. 9, middleware, which is capable of executing five components, is installed in the control unit 90. The five components include a communication processing component 91, an accumulation processing component 92, an image processing component 93, a print component 94, and a security component 95.

[S41] The mobile terminal 80 receives an input manipulation (for example, a touch manipulation) which is predetermined by a user, and outputs a signal, which indicates a request for print of the document data, toward the communication processing component 91.

[S42] The communication processing component 91 outputs a signal, which indicates a request for check (that is, security check) of the content relevant to the information security, toward the security component 95.

[S43] The security component 95 executes the security check using various pieces of information relevant to the content. Here, it is assumed that the security component 95 acquires a result of determination (OK) which approves the print of the content.

[S44] The security component 95 responds to the request (S42) from the communication processing component 91 by outputting a signal which indicates “OK” toward the communication processing component 91.

[S45] The communication processing component 91 receives the signal from the security component 95, and outputs a signal, which indicates that reception of the content starts, toward the mobile terminal 80.

[S46] The mobile terminal 80 receives the signal from the communication processing component 91, and starts transmission of the document data which is the print target.

[S47] The communication processing component 91 outputs a signal, which indicates a request for execution of a process of accumulating the document data received from the mobile terminal 80, toward the accumulation processing component 92.

[S48] The accumulation processing component 92 receives the signal from the communication processing component 91, and executes the process of accumulating the document data.

[S49] The accumulation processing component 92 outputs a signal, which indicates a request for execution of the image processing with respect to the accumulated document data, toward the image processing component 93.

[S50] The image processing component 93 receives the signal from the accumulation processing component 92, and executes a desired image processing with respect to the document data.

[S51] The image processing component 93 outputs a signal, which indicates a request for print of the output data (in the raster format or the vector format) acquired through the image processing, toward the print component 94.

[S52] The print component 94 executes print based on the acquired output data.

[S53] The print component 94 responds to the request (S51) from the image processing component 93 by outputting a signal, which indicates that the print is completed, toward the image processing component 93.

[S54] The image processing component 93 responds to the request (S49) from the accumulation processing component 92 by outputting a signal, which indicates that the image processing is completed, toward the accumulation processing component 92.

[S55] The accumulation processing component 92 responds to the request (S47) from the communication processing component 91 by outputting a signal, which indicates that the accumulation process is completed, toward the communication processing component 91.

[S56] The communication processing component 91 responds to the request (S41) from the mobile terminal 80 by outputting a signal, which indicates that the print of the document data is completed, toward the mobile terminal 80.

For example, in a case where the user visually recognizes a message “completion of print” displayed on the mobile terminal 80, the user moves toward the image forming apparatus and extracts previously discharged document of paper. Therefore, it is possible for the user to acquire and use the content (document data) of the user in a hard copy format.

FIG. 10 is a second sequence diagram illustrating operations of the control unit 90 and the mobile terminal 80 of FIG. 8. Since sequences in [S41] to [S42] are the same as the operations illustrated with reference to FIG. 9, the description thereof will not be repeated.

[S43] The security component 95 executes the security check using various pieces of information relevant to the content. Here, it is assumed that the security component 95 acquires a result of determination (N/A) that the print of the document data is not approved.

[S61] The security component 95 responds to the request (S41) from the communication processing component 91 by outputting a signal, which indicates “N/A”, toward the communication processing component 91.

[S62] The communication processing component 91 rejects reception of the content by outputting the signal, which indicates “N/A”, toward the mobile terminal 80.

[S63] The mobile terminal 80 executes a display process of displaying a notification that transmission of the document data is not approved. Therefore, warning is executed with respect to the user who possesses the mobile terminal 80.

Details of Countermeasure Control

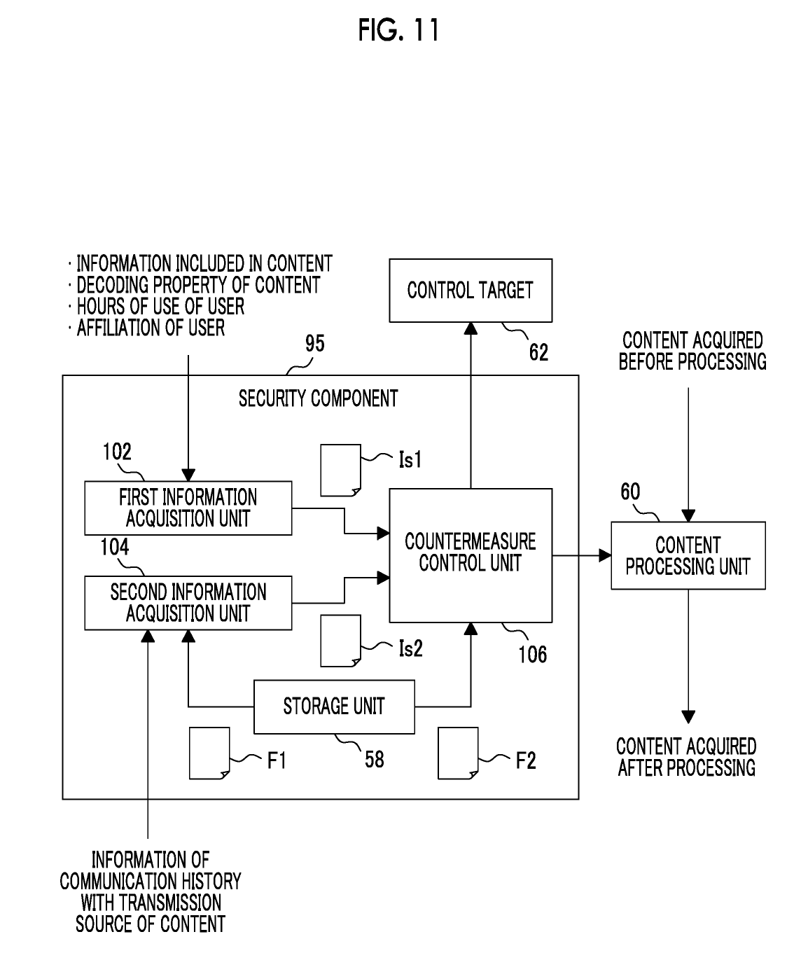

FIG. 11 is a functional block diagram illustrating the security component 95 illustrated in FIGS. 9 and 10. The security component 95 is configured to include a first information acquisition unit 102 (first acquisition section), a second information acquisition unit 104 (second acquisition section), a countermeasure control unit 106 (countermeasure control section), and a storage unit 58 (storage section). Meanwhile, similar to the case of the first exemplary embodiment, a plurality of types of data (for example, a setting file F1 and a guideline file F2) are stored in the storage unit 58.

The countermeasure control unit 106 controls at least one of the content processing unit 60 or the control target 62. Hereinafter, the countermeasure control executed by the security component 95 will be described in detail with reference to the flowchart of FIG. 6. However, steps, in which substantially the same operations as in the first exemplary embodiment are executed, will not be described, and only unique operations will be described in the second exemplary embodiment.

In step S31 of FIG. 6, the first information acquisition unit 102 acquires information (that is, the first security information Is1) which indicates the security level of the content. Here, similar to the case of the first exemplary embodiment, the first security information Is1 may include at least one of [1] information included in the content, [2] information indicative of a decoding degree of the content, [3] information indicative of hours of use of the user, or [4] information indicative of an affiliation of the user.

The “decoding degree of the content” includes not only a decoding degree of the document data itself and a decoding degree (a type of language or a quantity of technical terms) of the content itself of the document. For example, evaluation may be executed such that the decoding degree is relatively low in a case where the cipher process is executed in a case of reception from the mobile terminal 80, and the decoding degree is relatively high in a case where the cipher process is not executed.

In regards to the “information included in the content”, the “hours of use of the user”, and the “affiliation of the user”, the pieces of information which are described in the first exemplary embodiment (scan transmission) are used without change. Meanwhile, in the second exemplary embodiment (mobile print), the image forming apparatus 72 does not transmit the document data to the outside, and thus a fact that information corresponding to the “transmission destination of the content” does not exist should be remarked.

In step S32, the second information acquisition unit 104 acquires information (that is, the second security information Is2) which indicates the security state of the apparatus. Specifically, the second information acquisition unit 104 may acquire at least any one of [1] information indicative of security setting of the content processing unit 60 or [2] information indicative of a history of communication with a transmission source of the content.

The “history of communication” may be a communication log (a history of negotiation) which is generated until connection is established between the apparatus and the mobile terminal 80, or may be a communication log acquired after the connection is established. It is possible to grasp the security state of the content processing unit 60 at high accuracy through analysis of the communication log which is allowed to be acquired through the content treating procedure.

Since the countermeasure control unit 106 executes the countermeasure, which is selected in step S34, in step S35, the countermeasure control unit 106 outputs the control signal toward the content processing unit 60 and/or the control target 62. In the countermeasures 0 to 2 (execution/stop/suspension), the content processing unit 60 is the print unit 22. Meanwhile, the communication unit 25 may be added to the control target 62 in order to notify the user of each operation situation.

In the countermeasures 3 and 4 (notification), the control target 62 is at least the communication unit 25. In the countermeasure 5 (automatic change), the control target is at least the control unit 30. In addition, the communication unit 25 or the UI unit 26 may be added to the control target 62 in order to provide a notification that the security state is automatically changed to a third person.

### Advantage of Second Exemplary Embodiment

As described above, the image forming apparatus 72 as the information processing apparatus according to the second exemplary embodiment includes [1] the content processing unit 60, [2] the first information acquisition unit 102 (first acquisition section), [3] the second information acquisition unit 104 (second acquisition section), and [4] the countermeasure control unit 106 (countermeasure control section). Even with the configuration, the same advantage as in the case of the first exemplary embodiment (image forming apparatus 12) is acquired.

That is, in a case where the countermeasure related to the processing of the content (specifically, the mobile print) is dynamically selected and executed using the first security information Is1 and the second security information Is2, it is possible to execute the more appropriate countermeasure according to the security level of the content, compared to a case of fixedly working the security state which is set to the content processing unit 60 (specifically, the print unit 22).

### Modification Example

Meanwhile, the present invention is not limited to the above-described exemplary embodiments, and it is possible to freely perform change without departing from the gist of the present invention. Otherwise, it is apparent that respective configurations may be randomly combined in a range in which technical contradictions are not generated.

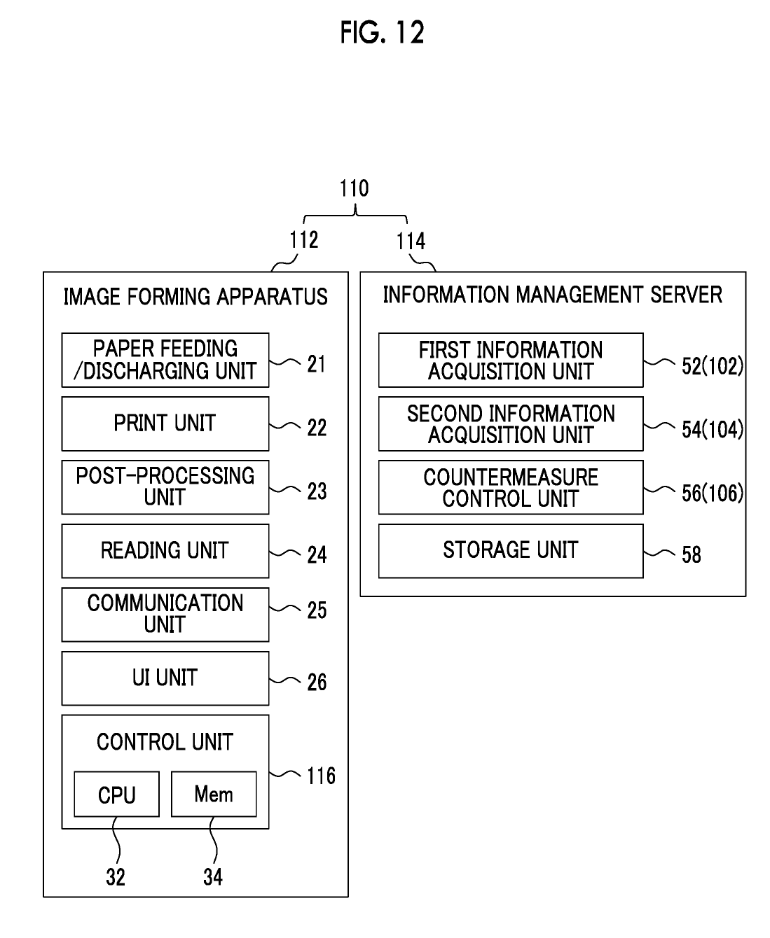

FIG. 12 is a configuration diagram illustrating an information processing apparatus 110 according to a modification example of the first and second exemplary embodiments. The information processing apparatus 110 is configured to include an image forming apparatus 112 and an information management server 114.

The image forming apparatus 112 is configured to include a paper feeding/discharging unit 21, a print unit 22, a post-processing unit 23, a reading unit 24, a communication unit 25, a UI unit 26, and a control unit 116 which has a function different from the first exemplary embodiment (the control unit 30 of FIG. 1) or the second exemplary embodiment (the control unit 90 of FIG. 8).

The information management server 114 is a computer in which a function corresponding to the security component 45 of FIGS. 2 and 3 is installed. That is, the information management server 114 is configured to include a first information acquisition unit 52, a second information acquisition unit 54, a countermeasure control unit 56, and a storage unit 58 (refer to FIG. 4). In contrast, the control unit 116 has a configuration which is basically identical to the control unit 30 (FIG. 1) according to the first exemplary embodiment, except a fact that the security component 45 of FIGS. 2 and 3 is not installed.

As above, a configuration corresponding to the security component 45 (FIGS. 2 and 3) may be provided in an apparatus (for example, the information management server 14), which is separated from the image forming apparatus 12, instead of being incorporated with the image forming apparatus 12 which includes the content processing unit 60. That is, in a case where the configuration (the image forming apparatus 112 and the information management server 114) of the information processing apparatus 110 is used, the same advantage as in the first exemplary embodiment (the image forming apparatus 12 of FIG. 1) may be acquired by timely executing exchange of the data via the network NW1.

Otherwise, the information management server 114 is a computer in which a function corresponding to the security component 95 of FIGS. 10 and 11 is installed. That is, the information management server 114 is configured to include a first information acquisition unit 102, a second information acquisition unit 104, a countermeasure control unit 106, and a storage unit 58 (refer to FIG. 11). In contrast, the control unit 116 has a configuration which is basically identical to the control unit 90 (FIG. 8) according to the second exemplary embodiment, except a fact that the security component 95 of FIGS. 10 and 11 is not installed.

As above, the configuration corresponding to the security component 95 (FIGS. 10 and 11) may be provided in an apparatus (for example, the information management server 74), which is separated from the image forming apparatus 72, instead of being incorporated with the image forming apparatus 72 which includes the content processing unit 60. That is, in a case where the configuration (the image forming apparatus 112 and the information management server 114) of the information processing apparatus 110 is used, the same advantage as in the second exemplary embodiment (the image forming apparatus 72 of FIG. 8) may be acquired by timely executing exchange of the data via the network NW1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processing section that processes content according to a variably set security state;
a first acquisition section that acquires first security information indicative of a security level of the content to be processed by the processing section;
a second acquisition section that acquires second security information indicative of a security state of the processing section; and
a countermeasure control section that executes dynamic selection from a plurality of predetermined countermeasures which include at least execution of a processing using the acquired first security information and second security information, and executes countermeasure control on the content.

2. The information processing apparatus according to claim 1,
wherein, in a case where the security state of the processing section does not satisfy a security condition which approves the processing of the content, the countermeasure control section executes the countermeasure control in order to change a currently set security state to a security state which satisfies the security condition.

3. The information processing apparatus according to claim 2,
wherein, in a case where the security state of the processing section is changed, the countermeasure control section limits an upper limit lifting width of the security level which approves the processing of the content.

4. The information processing apparatus according to claim 2,
wherein the countermeasure control section executes the countermeasure control by selecting any of a notification of an automatic change of the security state or a notification that urges a manual change of the security state.

5. The information processing apparatus according to claim 3,
wherein the countermeasure control section executes the countermeasure control by selecting any of a notification of an automatic change of the security state or a notification that urges a manual change of the security state.

6. The information processing apparatus according to claim 4, further comprising:
a user interface section that is configured to be able to input and output setting information indicative of the security state of the processing section,
wherein the countermeasure control section executes the countermeasure control to cause the user interface section to output an item or content of the setting information to be changed by a user.

7. The information processing apparatus according to claim 5, further comprising:
a user interface section that is configured to be able to input and output setting information indicative of the security state of the processing section,
wherein the countermeasure control section executes the countermeasure control to cause the user interface section to output an item or content of the setting information to be changed by a user.

8. The information processing apparatus according to claim 4,
wherein the countermeasure control section executes the countermeasure control, together with the notification of the automatic change of the security state or the notification that urges the manual change of the security state.

9. The information processing apparatus according to claim 5,
wherein the countermeasure control section executes the countermeasure control, together with the notification of the automatic change of the security state or the notification that urges the manual change of the security state.

10. The information processing apparatus according to claim 6,
wherein the countermeasure control section executes the countermeasure control, together with the notification of the automatic change of the security state or the notification that urges the manual change of the security state.

11. The information processing apparatus according to claim 7,
wherein the countermeasure control section executes the countermeasure control, together with the notification of the automatic change of the security state or the notification that urges the manual change of the security state.

12. The information processing apparatus according to claim 1,
wherein the first acquisition section acquires the first security information which includes at least one of information included in the content, information indicative of a transmission destination of the content, information indicative of a decoding degree of the content, information indicative of hours of use of a user, or information indicative of an affiliation of the user.

13. The information processing apparatus according to claim 2,
wherein the first acquisition section acquires the first security information which includes at least one of information included in the content, information indicative of a transmission destination of the content, information indicative of a decoding degree of the content, information indicative of hours of use of a user, or information indicative of an affiliation of the user.

14. The information processing apparatus according to claim 3,
wherein the first acquisition section acquires the first security information which includes at least one of information included in the content, information indicative of a transmission destination of the content, information indicative of a decoding degree of the content, information indicative of hours of use of a user, or information indicative of an affiliation of the user.

15. The information processing apparatus according to claim 4,
wherein the first acquisition section acquires the first security information which includes at least one of information included in the content, information indicative of a transmission destination of the content, information indicative of a decoding degree of the content, information indicative of hours of use of a user, or information indicative of an affiliation of the user.

16. The information processing apparatus according to claim 5,
wherein the first acquisition section acquires the first security information which includes at least one of information included in the content, information indicative of a transmission destination of the content, information indicative of a decoding degree of the content, information indicative of hours of use of a user, or information indicative of an affiliation of the user.

17. The information processing apparatus according to claim 1,
wherein the second acquisition section acquires the second security information which includes at least one of setting information indicative of the security state of the processing section or information indicative of a history of communication with a transmission source of the content.

18. The information processing apparatus according to claim 1, further comprising:
a storage section that stores a data file which includes a selection guideline to be used to select the countermeasure,
wherein the countermeasure control section reads the stored data file, and executes the countermeasure control according to the acquired selection guideline.

19. An information processing method of causing an information processing apparatus, which includes a processing section that processes content according to a variably set security state, to execute a process, the process comprising:
acquiring first security information indicative of a security level of the content to be processed by the processing section;
acquiring second security information indicative of a security state of the processing section; and
executing dynamic selection from a plurality of predetermined countermeasures which include at least execution of a processing using the acquired first security information and second security information, and executing countermeasure control on the content.

20. A non-transitory computer readable medium storing an information processing program causing an information processing apparatus, which includes a processing section that processes content according to a variably set security state, to execute a process, the process comprising:
acquiring first security information indicative of a security level of the content to be processed by the processing section;
acquiring second security information indicative of a security state of the processing section; and
executing dynamic selection from a plurality of predetermined countermeasures which include at least execution of a processing using the acquired first security information and second security information, and executing countermeasure control on the content.
